(19) United States
(12) Patent Application Publication
(10) Pub. No.: US 2014/0127369 A1
(43) Pub. Date: May 8, 2014

(54) COMPOSITION CONTAINING CHRYSANTHEMUM INDICUM L. EXTRACT FOR PREVENTING DISCOLORATION

(71) Applicants: Gun Hee Kim, Seoul (KR); Min Sun Chang, Seoul (KR)

(72) Inventors: Gun Hee Kim, Seoul (KR); Min Sun Chang, Seoul (KR)

(73) Assignee: DUKSUNG WOMEN'S UNIVERSITY INDUSTRY-ACADEMIC COOPERATION FOUNDATION, Seoul (KR)

(21) Appl. No.: 14/124,245

(22) PCT Filed: Oct. 13, 2011
(86) PCT No.: PCT/KR2011/007642

§ 371 Date: Dec. 5, 2013

(30) Foreign Application Priority Data
Jun. 7, 2011 (KR) 10-2011-0054683

(51) Int. Cl. A23B 7/154

(52) U.S. Cl. CPC A23B 7/154
USPC 426/270; 426/654

(57) ABSTRACT

Disclosed are antibrowning agents containing the extracts of chrysanthemum indicum for preventing browning of fruits and vegetables, wherein the extracts of chrysanthemum having good effects on inhibition of polyphenol oxidase activity effectively prevent the browning of fruits and vegetables.

### TECHNICAL FIELD

The present invention relates to antibrowning agents containing the extracts of natural plant, and more particularly to antibrowning agents containing the extracts of CHRYSANTHEMUM INDICUM L. for preventing browning of fruits and vegetables.

### BACKGROUND ART

Recently, people who attach greater importance to health demands and consumes fresh pieces of agricultural products. These fresh pieces of agricultural products may have serious problems of color change, textural change and microorganism propagation due to tissue damages which might occur during cutting and peeling processes. Especially, browning may be a main factor having great influence on quality of products, that is, may relate with quality indicator of products, merchantability.

The browning is the process of color change, especially, the process of becoming brown in foods during cooking, food processing and storage. The browning may be caused by pigments contained in foods, heat generated for the cooking and food processing, or long-term storage.

It is generally known that the browning is involved with phenol compounds. During food processing or storing process, the phenol compounds cause enzymatic browning involving polyphenol oxidase (PPO) or non-enzymatic browning. In order to prevent the browning, various materials may be used, for example, reducing agent of vitamin C and natural sulfur compounds, acidifier for delaying the browning by lowering pH, and chelating substances for inhibition of PPO activity. However, there is a recently-increasing consumer's demand on natural antibrowning agents. Accordingly, natural antibrowning agents using medicinal plants and tea have been searched and studied, however, these studies have been scarcely applied to agricultural products.

### DISCLOSURE

### Technical Problem

Therefore, the present invention has been made in view of the above problems, and it is an object of the present invention to provide antibrowning agents containing an active component corresponding to the extracts of natural plants for realizing good merchantable quality in fresh pieces of fruits and vegetables.

### Technical Solution

To achieve these objects and other advantages and in accordance with the purpose of the invention, as embodied and broadly described herein, there is provided fruits and vegetables antibrowning agents containing an active component corresponding to the extracts of chrysanthemum indicum.

Also, there is provided an antibrowning method of fruits and vegetables by treating fruits and vegetables with antibrowning agents containing an active component corresponding to the extracts of chrysanthemum indicum.

Also, there is provided fruits and vegetables antibrowning agents containing an active component corresponding to the extracts of chrysanthemum indicum.

The active component of the agents, that is, chrysanthemum indicum, which is a perennial plant belong to Compositae, is generally known as wild chrysanthemum which widely spread in the mountainous area of the central and southern regions in Korea. From old times, a rice wine flavored with chrysanthemum indicum, called ‘gukhwaju’, was used in the royal court. In the people, chrysanthemum indicum was used as medicinal liquor for hypertension patents.

As generally known, main ingredients of chrysanthemum indicum are flavonoid compounds such as luteolin, apigenin and acacetin, sesquiterpene lacton compounds such as cumambrin A and B, arteglasin A and angeloyljadin. There were various studies, for example, a study on gelatinization and retrogradation of steamed rice cake by addition of chrysanthemum indicum in a sitological aspect, and quality properties and preference, a study on optical extraction conditions of chrysanthemum floral leaves for realization of high quality in traditional liquor, and etc.

Many studies for antioxidative activity of chrysanthemum indicum were performed, however, studies on antibrowning of foods are currently insufficient. The present invention shows that the extracts of chrysanthemum indicum have good effects on inhibition of browning in foods.

The extracts of chrysanthemum indicum according to the present invention show good effects on inhibition of polyphenol oxidase (PPO) activity causing the browning, which enables to prevent an enzymatic browning reaction, (See the embodiment 1). Also, the extracts of chrysanthemum indicum according to the present invention show good antioxidative effects by free radical scavenging activity (See the embodiment 2), high total phenol content and total flavonoid content (See the embodiment 3), and good chelating effects on metal ions (See the embodiment 4). Also, apple slices treated with the extracts of chrysanthemum indicum are scarcely changed in their surface colors, that is, the extracts of chrysanthemum indicum prevent the browning in the apple slices (See the embodiment 6).

The extracts of chrysanthemum indicum according to the present invention may be obtained from flowers, leaves, stems, roots, or all bodies of chrysanthemum indicum, and more preferably flowers or leaves of chrysanthemum indicum, and most preferably flowers of chrysanthemum indicum.

The extracts of chrysanthemum indicum may be extracted by the use of various extraction solvents in various extraction methods, and more preferably, hot water extraction or ethanol solvent extraction.

In case of the hot water extraction, distilled water may be used as an extraction solvent, and the extracts of chrysanthemum indicum may be extracted at a temperature of 30 to 80° C., and more preferably 40 to 70° C., and most preferably 60° C. .

In case of the ethanol solvent extraction, an extracted ethanol solvent is 50 to 90% ethanol, and more preferably 60 to 85% ethanol, and most preferably 70 to 80% ethanol.

The extracts of chrysanthemum indicum according to the present invention are included within 0.01 to 100.0 weight % of a total weight of antibrowning agents. If the extracts of chrysanthemum indicum are included less than 0.01 weight %, the antibrowning effect is insufficient, whereby it cannot be used for the antibrowning agents in fruits and vegetable.

In order to enhance the antibrowning effect, the antibrowning agents of the present invention may further include at least one antibrowning agent selected among ascorbic acid, sodium polyphosphate, citric acid, L-cysteine, kojic acid and calcium chloride.

The antibrowning agents of the present invention may be applied to all kinds of fruits and vegetables with the browning, and more preferably, apple, pear, banana, sweet persimmon, apricot, potato, sweet potato, eggplant, garlic, and etc.

Hereinafter, an antibrowning method for fruits and vegetable by treating fruits and vegetables with the antibrowning agents containing the extracts of chrysanthemum indicum according to the present invention will be described.

The antibrowning method according to the present invention may be achieved by immersing the fruits and vegetables into the antibrowning agents containing the extracts of chrysanthemum indicum (1), or adding the antibrowning agents containing the extracts of chrysanthemum indicum to fruit juice (2).

According to the present invention, in case of the above method of immersing the fruits and vegetables into the antibrowning agents containing the extracts of chrysanthemum indicum, the antibrowning agents may be 0.1 to 100.0 weight % with respect to a total weight of the fruits and vegetables. This method of immersing the fruits and vegetables into the antibrowning agents containing the extracts of chrysanthemum indicum may be used when treating the fruits and vegetables intact without any processing, and further when making dried snacks with the fruits and vegetables, for example, apple chips or potato chips, to thereby effectively prevent the antibrowning.

According to the present invention, in case of the above method of adding the antibrowning agents containing the extracts of chrysanthemum indicum to the juice of fruits and vegetables, the antibrowning agents may be 0.05 to 50.0 weight % with respect to a total weight of the juice of fruits and vegetables. Thus, when the fruit juice is produced by spraying the antibrowning agents containing the extracts of chrysanthemum indicum thereto in a juice production plant, it is possible to obtain more juice without the browning. As a result, an expensive machine used for prevention of the browning in fruits may be substituted by the antibrowning agents containing the extracts of chrysanthemum indicum according to the present invention. Also, if producing green tea beverage canned or bottled, it is possible to prevent the browning by the above method of adding the antibrowning agents containing the extracts of chrysanthemum indicum thereto.

According to the present invention, even though the fruits and vegetables are stored for a long time, the fruits and vegetables are maintained without the color change, that is, browning, and furthermore the scent of fruits is not changed.

### Advantageous Effects

Accordingly, the antibrowning agents containing the extracts of chrysanthemum indicum according to the present invention have the following advantages.

The agents of the present invention having good effects on inhibition of polyphenol oxidase (PPO) activity, good antioxidative effects and good chelating effects may be used for the antibrowning in fruits and vegetables.

### DESCRIPTION OF DRAWINGS

FIG. 1 is a photograph showing respective surfaces of an apple slice treated with hot water extracts from chrysanthemum indicum, an apple slice treated with ethanol extracts from chrysanthemum indicum, and an non-treated apple slice after being stored at a room temperature for 24 hours.

### BEST MODE

Reference will now be made in detail to the preferred embodiments of the present invention, examples of which are illustrated in the accompanying drawings. Herein, the following examples of the present invention are provided to describe the present invention in detail, that is, the range of the present invention will not be limited to the following description.

### Preparation Example 1

### Preparing Hot Water Extracts from Chrysanthemum Indicum

First, chrysanthemum indicum, cultivated in Uiseong-gun of Gyeongsangbuk-do, is dried and crushed. Under the circumstances that 150 ml of distilled water is poured into 30 g of the dried and crushed chrysanthemum indicum, and is put into a shaking bath at a temperature of 60° C., the extracts are obtained repeatedly three times for 6 hours. After the obtained extracts are centrifuged at 5,000 g for 15 minutes, supernatent is taken and freeze-dried, which is used as a sample of the extracts of chrysanthemum indicum.

### Preparation Example 2

### Preparing Ethanol Extracts from Chrysanthemum Indicum

First, chrysanthemum indicum, cultivated in Uiseong-gun of Gyeongsangbuk-do, is dried and crushed. Under the circumstances that 150 ml of 80% ethanol solution is poured into 30 g of the dried and crushed chrysanthemum indicum, and is put into a reflux cooling device at a temperature of 60° C., the extracts are obtained repeatedly three times for 6 hours. After the obtained extracts are centrifuged at 5,000 g for 15 minutes, supernatent is taken and freeze-dried, which is used as a sample of the extracts of chrysanthemum indicum.

### Embodiment 1

### PPO Activity Inhibition by the Extracts of Chrysanthemum Indicum

As an activity of polyphenol oxidase (PPO) causing browning becomes lower, an antibrowning activity becomes higher. An effect on inhibition of PPO activity is measured by the use of extracts of chrysanthemum indicum obtained in the above preparation examples.

For a substrate, catethin (purchased from signa Chem. Co.), which is generally contained in fruits and vegetables, is used. Also, mushroom polyphenol oxidase is purchased from signal Chem. Co. The experimental method will be described as follows.

The extracts of chrysanthemum indicum obtained in the above preparation examples (0%, 0.5%, 1.0%, 1.5%) and catethin 4.0 mM are dissolved in a phosphate buffer (ph 6.5). After mixing 1.0 ml of catethin solution with 0.1 ml of the extracts of chrysanthemum indicum, 0.2 ml of mushroom polyphenol oxidase is put thereto for reaction with the above mixture. A change of absorbance is measured at 420 nm for 3 minutes by the use of Diode Array spectrophotometer (Hewlett Packard Inc., Palo Alto, Calif.). A maximal initial velocity (AOD/min) is determined in an absorbance vs. time graph by a software provided by Hewlett Packard Inc. A unit of polyphenol oxidase (PPO) activity is determined by an increase in a degree of absorbance of 1.0/min/mg protein at 25° C., 420 nm. An inhibition (%) of PPO activity in the reaction may be calculated by the following Equation 1,

Inhibition of PPO activity (%)=[1−(A*/A)]×100 [Equation 1]

wherein, ‘A*’ is an enzymatic activity when a treatment using
the extracts of chrysanthemum indicum is performed, and ‘A’ is an enzymatic activity when a treatment using the extracts of chrysanthemum indicum is not performed.

As shown the following Table 1, according as concentration of the extracts of chrysanthemum indicum is increased, the inhibition effect of PPO activity is dose-dependently increased. In the same concentration, the inhibition effect of PPO activity in the ethanol extracts from chrysanthemum indicum is slightly higher than the inhibition effect of PPO activity in the hot water extracts from chrysanthemum indicum, and IC₅₀ value (1.97%) of the ethanol extracts from chrysanthemum indicum is more than two times IC₅₀ value (3.32%) of the hot water extracts from chrysanthemum indicum. Accordingly, the extracts of chrysanthemum indicum show good effects on inhibition of PPO activity, and the ethanol extracts from chrysanthemum indicum among the various extraction solvents have the best effects on inhibition of PPO activity.

TABLE 1
Effects on inhibition of PPO activity

| | Hot water extracts from | | Ethanol extracts from | |
|---|---|---|---|---|
| | chrysanthemum indicum | | chrysanthemum indicum | |
| | (Preparation example 1) | | (Preparation example 2) | |
| Treatment | Inhibition of | IC₅₀ | Inhibition of | IC₅₀ |
| concentration (%) | PPO activity (%) | (%) | PPO activity (%) | (%) |
| 0.5 | 32.61 ± 1.27 | 3.32 | 35.27 ± 0.59 | 1.97 |
| 1.0 | 73.52 ± 2.28 | | 77.94 ± 4.64 | |
| 1.5 | 83.03 ± 1.27 | | 89.85 ± 1.48 | |

### Embodiment 2

### Antioxidative Effects in the Extracts of Chrysanthemum Indicum

In order to measure antioxidative effects in the extracts of chrysanthemum indicum, an DPPH radical scavenging activity is measured. Herein, ‘DPPH’ is stable free radical, wherein ‘DPPH’ shows the maximum absorption at about 517 nm by its unshared electron, and the absorbance of ‘DPPH’ is reduced at about 517 nm when it receives electron or hydrogen. If an ability for radical reduction or offsetting is high, the high antioxidative effect is expected.

Also, ‘DPPH’ method is for measuring the antioxidative activity by the reduction power through the use of free radical such as DPPH(2,2-Di(4-tert-octylphenyl)-1-picrylhydrazyl) free radical. A free radical scavenging rate is measured at 517 nm wavelength by comparing absorbance of blank solution with a decreased degree of absorbance by the DPPH reduction through the extracts of chrysanthemum indicum.

Herein, a reagent used is 100 ml obtained by dissolving 61.88 mg of 2,2-Di (4-tert-octylphenyl)-1-picrylhydrazyl free radical (Aldrich Chem Co., MW=618.76) as 0.1 mM solution in methanol.

The specific measuring methods are as follows.

1) 2.8 ml of 0.2 mM DPPH solution and 0.2ml of 1% sample solution are quickly stirred in 96-well plate, and allowed to react for 10 minutes at 25° C. Then, the absorbance at 517 nm, ‘A*’, is measured.

2) The procedure of sample solution in the blank (Blank) is the same as above, except that the distilled water and 80% ethanol are used instead of 0.2 mM DPPH solution. Then, the absorbance ‘A’ is measured.

Free radical scavenging rate was calculated by the following equation (2), and the results are shown in the following Table 2.

DPPH radical scavenging activity (%)=[1−(A*/A)]×100 [Equation 2]

In equation 2, ‘A*’ is the absorbance at 517 nm. after the free radical scavenging of the sample solution (treatment using the extracts of chrysanthemum indicum), and ‘A’ is the absorbance at 517 mn after the free radical scavenging of the blank test solution (without treatment using the extracts of chrysanthemum indicum).

TABLE 2
DPPH free radical scavenging rate (%)

| Treatment concentration (%) | Free radical scavenging rate (%) |
|---|---|
| Hot water extract from Chrysanthemum | 20.88 ± 0.28 |
| indicum (1%) | |
| ethanol extract from Chrysanthemum | 76.10 ± 0.09 |
| indicum (1%) | |

As known from the above Table 2, the extracts of chrysanthemum indicum show the free radical scavenging effect through the DPPH radical scavenging test, and the free radical scavenging effect in the ethanol extract from chrysanthemum indicum is far superior to the free radical scavenging effect in the hot water extract from chrysanthemum indicum.

### Example 3

### Measurement of Total Phenol and Total Flavonoid Content

The antioxidative effects of plants correlate with total polyphenol content and total flavonoid content. This total polyphenol and flavonoid content in the extract of chrysanthemum indicum with excellent free radical scavenging effect is measured.

The total polyphenol content is measured in the Folin-Cio alteu method. After mixing 0.1 ml of the extract sample of chrysanthemum indicum with 0.5 ml of 2 N Folin-Ciocalteu reagent, the mixture is maintained at a room temperature for 3 minutes, and then 1 ml of 20% Na₂ CO₃ solution is added thereto, and is again maintained at a room temperature for 1 hour. Thereafter, the absorbance is measured at 750 nm. Herein, the standard solution of garlic acid (gallic acid) is used.

The total flavonoid content is measured in the Nieva Moreno method. After adding 0.2 ml of the extract sample of chrysanthemum indicum with 2 ml of diethylene glycol and 0.2 ml of 1N NaOH, the mixture is incubated in 37° C. water bath for 1 hour, and then the absorbance is measured at 420 nm. Herein, the total flavonoid content is calculated from the standard curve created using naringin (Nieva Moreno MI, Isla MI, Sampietro AR, VAttuone MA. Comparision of the free radical-scavenging activity of propolis from several regions of Argentina. J. Ethnopharmacol. 71:109-114 (2000)).

As a result, as shown in the following Table 3, the total phenol and flavonoid content in the ethanol extract from chrysanthemum indicum is higher than the total phenol and flavonoid content in the hot water extract from chrysanthemum indicum. That is, the total phenol and flavonoid content in the ethanol extract from chrysanthemum indicum, provided with the excellent free radical scavenging effect, is higher than the total phenol and flavonoid content in the hot water extract from chrysanthemum indicum. Thus, it is possible to know the phenol content and total flavonoid content highly correlates with the free radical scavenging effect.

TABLE 3
Analysis of total phenol content and total flavonoid content

| | Total phenol | Total flavonoid |
|---|---|---|
| Division | content (%) | content (%) |
| Hot water extract from | 86.92 ± 2.13 | 82.39 ± 3.23 |
| chrysanthemum indicum | | |
| Ethanol extract from | 94.07 ± 3.08 | 102.60 ± 3.22 |
| chrysanthemum indicum | | |

### Embodiment 4

### Chelating Effect for the Oxidation Promoter of the Extracts of Chrysanthemum Indicum

The metal chelating agent reduces the oxidation-reduction potential to stabilizes the oxidation state of the metal ion, whereby the metal chelating agent is very important enough to be referred to as the second antioxidant. In this experiment, Fe^{e+} is the most powerful oxidation promoter of various metal ions, and thus ‘Fe²⁺’ chelating effect of the extracts of chrysanthemum indicum is measured.

In order to measure the metal chelating effect, 0.1 ml, of 2 mM FeCl₂ is added to 0.3 ml, of the ethanol extract from chrysanthemum indicum, and then 0.2 mL of 5 mM ferrozine and 3.4 mL of ethanol are added thereto. Thereafter, the mixture is maintained at a room temperature for 10 minutes, and the absorbance is measured at 562 nm by the use of Microplate reader (M2, Molecular Device, Canada). The metal chelating effect is calculated in accordance with the following Equation 3.

Metal chelating effect (%)=[1−(A/B)]×100 [Equation 3]

(A: absorbance of ward with added sample, B: absorbance of ward without added sample)

As a result, as shown in the following Table 4, the chelating effect in the hot water extract from chrysanthemum indicum is 24.98%, and the chelating erect in the ethanol extract from chrysanthemum indicum is 5.37%, That is, it can be said that the chelating effect with the ferrous ion in the hot water extract from chrysanthemum indicum is higher than the chelating effect with the ferrous ion in the ethanol extract from chrysanthemum indicum.

TABLE 4
Chelating effect (%)

| Division | Metal chelating effect (%) |
|---|---|
| Hot water extract from chrysanthemum | 24.98 ± 2.73 |
| indicum | |
| Ethanol extract from chrysanthemum | 5.37 ± 1.31 |
| indicum | |

### Embodiment 5

### Analysis of Mineral Content in the Extracts of Chrysanthemum Indicum

The mineral content in the extracts of chrysanthemum indicum is analyzed.

The mineral content is analyzed by the use of Perkin Elmer's minerals automatic analyzer ICP-AES (Hergenreder PerkinElmer Inc, Shelton, Conn., USA).

As a result, as shown in the following Table 5, the overall mineral content of the hot water extract from chrysanthemum indicum is high, especially, K content of 99849.33 ppm. In case of the ethanol extract from chrysanthemum indicum, the mineral content of Fe and Mn is not detected.

TABLE 5
Analysis of mineral content

| | Hot water extract from | Ethanol extract from |
|---|---|---|
| Ingredients (ppm) | chrysanthemum indicum | chrysanthemum indicum |
| Ca | 5211.32 | 122.35 |
| Mg | 4555.05 | 444.22 |
| Fe | 14.34 | N.D. |
| Zn | 46.95 | 23.55 |
| Cu | 16.42 | 21.67 |
| Mn | 90.36 | N.D. |
| K | 99849.33 | 40391.33 |

N.D.: non detected (not detected)

### Embodiment 6

### Browning Inhibitory Effect on the Apple Slices

In order to check the browning inhibitory effect of the extracts of chrysanthemum indicum, apple slices are immersed into the extracts of chrysanthemum indicum, and the color changes are observed.

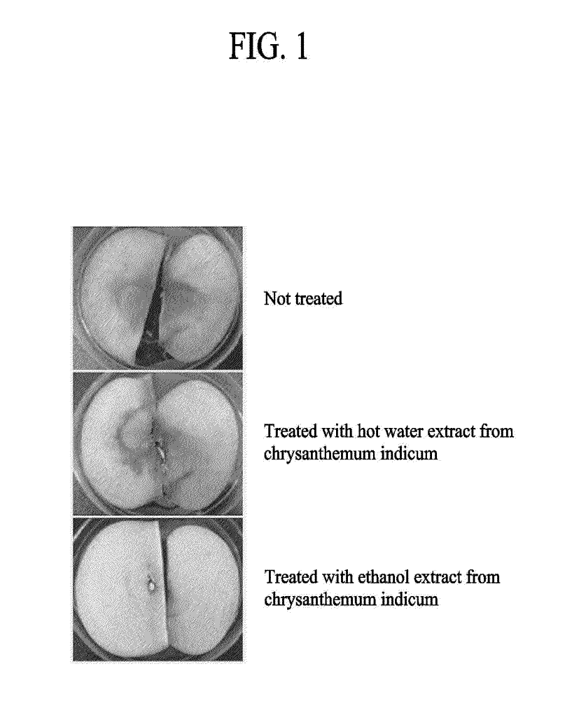

The purchase ‘Fuji’ cuitivar, harvested from Gyeongbuk Yeongcheon in 2011, with good surfaces, was selected and used in the experiment. After making the apple slice with 15 mm thickness by the use of ceramic knife, the apple slice is immersed into 20 ml of 1% solution of the extracts of chrysanthemum indicum for 1 minute, and is then naturally dried for 3 minutes. Then, after gently removing moisture from the naturally-dried apple chip by the use of moisture absorbent paper, the apple chip is maintained at a room temperature for 24 hours, and the color change in the surface of apple chip is measured. The color change is checked by measuring ‘L value’ (lightness, brightness), ‘a value’ (redness, red color tone) and ‘b value’ (yellowness, yellow color tone), and ‘ΔE value’ of the overall color change is calculated by the ‘L value’, ‘a value’ and ‘b value’. Herein, ‘L value’, ‘a value’, ‘b value’ and ‘ΔE value’ are measured in Chroma meter (Model CR-200, Minolta Camera Co., Osaka, Japan) whose scales are determined with white tile (white tile, L=100.00, a=−0.43, and b=+0.43). Also, the total chrommance ΔE is calculated in accordance with the following Equation 4. The results are shown in the following Table 6, and the real photographs are shown in FIG. 1.

ΔE=\sqrt{ΔL²+Δa²+Δb²} [Equation 4]

As a result, as shown in the following Table 6, while ‘L value’ in the apple slice which is not treated with the extracts of chrysanthemum indicum is 52.50, ‘L value’ in the apple slice which is treated with the hot water extract from chrysanthemum indicum is 78.26, and ‘L value’ in the apple slice which is treated with the ethanol extract from chrysanthemum indicum is 78.82. That is, ‘L value’ in the apple slice which is treated with the extracts of chrysanthemum indicum is higher than ‘L value’ in the apple slice which is not treated with the extracts of chrysanthemum indicum. When it shows higher ‘L value’, minus ‘a value’ and lower ‘b value’, it is evaluated as the low browning phenomenon. Also, while ‘AE value’ in the apple slice which is not treated with the extracts of chrysanthemum indicum represents the color change of 17.08, ‘ΔL value’ in the apple slice which is treated with the hot water extract from chrysanthemum indicum represents the color change of 3.41, and ‘ΔE value’ in the apple slice which is treated with the ethanol extract from chrysanthemum indicum represents the color change of 2.22. Thus, when the apple slice is treated with the extracts of chrysanthemum indicum, the color change is lowered. Especially, if the apple slice is treated with the ethanol extract from chrysanthemum indicum, the color change is more lowered.

The change of ‘L value’ relates with the increase of PPO activity. When tissues age or are under stress, PPO is very soluble and activated.

TABLE 6

| | | Hot water extract | Ethanol extract |
|---|---|---|---|
| | | from | from |
| | | chrysanthemum | chrysanthemum |
| Division | Untreated | indicum | indicum |
| L (lightness) | 52.50 ± 6.89 | 78.26 ± 1.12 | 72.82 ± 0.98 |
| a (redness) | −39.61 ± 4.30 | −46.57 ± 0.35 | −48.01 ± 0.50 |
| B (yellowness) | 13.72 ± 1.68 | 15.53 ± 0.80 | 12.99 ± 1.22 |
| ΔE | 17.08 | 3.41 | 2.22 |

### Preparation Example 3

### Preparing Antibrowning Agent Containing the Extracts of Chrysanthemum Indicum

The antibrowning agent containing the extracts of chrysanthemum indicum prepared in the above preparation example 2 is prepared. In case of the hot water extract from chrysanthemum indicum of the preparation example 2, the antibrowning agent is prepared by adding 0.1 g of freeze-dried powder of the hot water extract in 10 ml of distilled water. In case of the ethanol extract from chrysanthemum indicum the antibrowning agent is prepared by adding 0.1 g of freeze-dried powder of the ethanol extract 10 ml of 80% ethanol.

### Preparation Example 4

### Preparing Foods Using the Antibrowning Agent Containing the Extracts of Chrysanthemum Indicum

### <4-1> Preparing Powder

### 1. Preparing Sweet Potato Powder

After immersing 1 kg of sweet potato being washed and sliced into 100 ml of the antibrowning agent of the preparation example 3, 70° C. hot-air drying is performed to prepare sweet potato slices. Then, the prepared sweet potato slices are cut into particle size of 80 mesh by the use of mixer, to thereby prepare sweet potato powder.

### 2. Preparing Potato Powder

After immersing 1 kg of potato being washed and sliced into 100 ml of the antibrowning agent of the preparation example 3, 70° C. hot-air drying is performed to prepare potato slices. Then, the prepared potato slices are cut into particle size of 80 mesh by the use of mixer, to thereby prepare potato powder.

### <4-2> Preparing Dry Snacks

### 1. Preparing Potato Chips

After immersing 1 kg of potato being washed and sliced at 1 mm thickness into 100 ml of the antibrowning agent of the preparation example 3, 80° C. hot-air drying is performed, thereby preparing potato chips.

### 2. Preparing Sweet Potato Chips

After immersing 1 kg of sweet potato being washed and sliced at 1 mm thickness into 100 ml of the antibrowning agent of the preparation example 3, 80° C. hot-air drying is performed, thereby preparing sweet potato chips.

### 3. Preparing Apple Chips

After immersing 1 kg of apple being washed and sliced at 1 mm thickness into 100 ml of the antibrowning agent of the preparation example 3, 80° C. hot-air drying is performed, thereby preparing apple chips.

What is claimed is:

1. Antibrowning agents for fruits and vegetables, the antibrowning agents containing the extracts of chrysanthemum indicum as an active component.

2. The antibrowning agents for fruits and vegetables as claimed in claim 1, wherein the extracts of chrysanthemum indicum are included within a range of 0.01 to 100 weight % with respect to a total weight of agents.

3. An antibrowning method for fruits and vegetables by treating fruits and vegetables with antibrowning agents containing the extracts of chrysanthemum indicum.

4. The antibrowning method as claimed in claim 3, wherein the antibrowning method includes (1) immersing the fruits and vegetables into the antibrowning agents containing the extracts of chrysanthemum indicum, or (2) adding the antibrowning agents containing the extracts of chrysanthemum indicum to fruit juice.

5. The antibrowning method as claimed in claim 4, wherein the antibrowning method includes immersing the fruits and vegetables into the antibrowning agents containing the extracts of chrysanthemum indicum within a range of 0.1 to 100 weight % with respect to a total weight of the fruits and vegetables.

6. The antibrowning method as claimed in claim 4, wherein the antibrowning method includes adding the antibrowning agents containing the extracts of chrysanthemum indicum to fruit juice within a range of 0.05 to 50 weight % with respect to a total weight of the fruit juice.
